(19) United States
(12) Patent Application Publication
(10) Pub. No.: US 2008/0240887 A1
(43) Pub. Date: Oct. 2, 2008

(54) IMAGE FORMING APPARATUS, METHOD OF CONTROLLING THE APPARATUS, AND STORAGE MEDIUM STORING COMPUTER EXECUTABLE PROGRAM CODE FOR EXECUTING THE METHOD

(76) Inventors: Hiroshi GOTOH, Tokyo (JP); Yutaka MATSUMOTO, Saitama-shi (JP); Satoshi MIYAZAKI, Kawasaki-shi (JP); Takeshi YOSHIZUMI, Tokyo (JP); Naohiko KUBO, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/057,818

(22) Filed: Mar. 28, 2008

(30) Foreign Application Priority Data
Mar. 28, 2007 (JP) 2007-085681

(51) Int. Cl. B42C 11/04; G03G 15/00

(52) U.S. Cl. 412/4; 399/397; 399/408

(57) ABSTRACT

An image forming apparatus connectable to a bookbinding apparatus that binds a sheet stack with a cover sheet to produce a book includes an information acquisition unit, an area designation unit, and an image forming unit. The cover sheet includes a front cover area, a back cover area, and a spine area located between the front cover area and the back cover area. The information acquisition unit acquires information on a width of the spine area in the cover sheet prior to binding the sheet stack. The area designation unit designates an image formation area in which an image is to be formed in the cover sheet based on the information on the width of the spine area acquired by the information acquisition unit. The image formation area includes the spine area. The image forming unit forms the image in the image formation area designated by the area designation unit.

### CROSS-REFERENCE TO RELATED APPLICATIONS

The present patent application claims priority under 35 U.S.C. §119 from Japanese Patent Application No. 2007-085681, filed on Mar. 28, 2007 in the Japan Patent Office, the entire contents of which are hereby incorporated herein by reference.

### BACKGROUND OF THE INVENTION

1. Field of the Invention

The present invention relates to an image forming apparatus, a method of controlling the image forming apparatus, and a storage medium storing a computer program for executing the method, and more specifically, an image forming apparatus connectable to a bookbinding apparatus that binds a stack of sheets to produce a book and capable of forming an image on a cover sheet that covers the stack of sheets.

2. Description of the Background

With advances in information digitization, image forming apparatuses such as printers, facsimile machines, and scanners have been increasingly used to output digitized information or digitize paper documents. Certain image forming apparatuses have image capture, image formation, and communication capabilities, and are configured as multi-functional devices operable as a printer, facsimile machine, scanner, and copier.

One type of conventional image forming apparatus is configured to be connectable to a bookbinding apparatus for executing bookbinding processing for added convenience. In such a case, when the image forming apparatus executes image formation on a plurality of sheets using a printer or copier function, the bookbinding apparatus receives and binds the sheets to produce a book.

In this regard, when the bookbinding apparatus binds or wraps a stack of documents or sheets, which has been output from the image forming apparatus, with a cover sheet to produce a bound book, it is preferable that the image forming apparatus be capable of forming an image on the cover sheet as well. When performing the image formation on the cover sheet, however, it may be difficult to form an image on a spine area of the cover sheet, which serves as a spine in a final bound book.

Accordingly, one conventional image forming method, when performing image formation, calculates the thickness of a stack of sheets output as a target of bookbinding processing and then defines such a spine area as a margin area or blank space based on the thickness of the stack and a height at which the cover sheet is folded in the bookbinding process.

However, the conventional image forming method sets a spine area in a cover sheet only as a margin, and is not designed to execute image formation on a spine.

Consequently, there is still a need for an image forming apparatus connectable to a bookbinding apparatus that binds a stack of sheets to produce a book and capable of forming an image on a cover sheet that covers the stack of sheets.

### SUMMARY OF THE INVENTION

Exemplary embodiments of the present invention provide an image forming apparatus connectable to a bookbinding apparatus that binds a stack of sheets to produce a book and capable of forming an image on a cover sheet that covers the stack of sheets.

In one exemplary embodiment of the present invention, an image forming apparatus connectable to a bookbinding apparatus that binds a sheet stack with a cover sheet to produce a book includes an information acquisition unit, an area designation unit, an image forming unit and a sheet feed tray. The cover sheet includes a front cover area, a back cover area, and a spine area located between the front cover area and the back cover area. The information acquisition unit acquires information on a width of the spine area in the cover sheet prior to binding the sheet stack. The area designation unit designates an image formation area in which an image is to be formed in the cover sheet based on the information on the width of the spine area acquired by the information acquisition unit. The image formation area includes the spine area. The image forming unit forms the image in the image formation area designated by the area designation unit.

In another exemplary embodiment, a method of controlling an image forming apparatus connectable to a bookbinding apparatus that binds a sheet stack with a cover sheet to produce a book, the cover sheet comprising a front cover area, a back cover area, and a spine area located between the front cover area and the back cover area, includes acquiring information on a width of the spine area in the cover sheet prior to binding the sheet stack, designating an image formation area in which an image is to be formed in the cover sheet based on the information on the width of the spine area acquired in the acquiring, with the image formation area including the spine area, and forming the image in the image formation area designated by the designating.

In yet another exemplary embodiment, a computer-readable storage medium stores a computer program that causes a computer to execute the method of controlling an image forming apparatus described above.

### BRIEF DESCRIPTION OF THE DRAWINGS

A more complete appreciation of the disclosure and many of the attendant advantages thereof will be readily acquired as the same becomes better understood by reference to the following detailed description when considered in connection with the accompanying drawings, wherein:

FIG. 1 is a block diagram illustrating a configuration of an image forming apparatus according to exemplary embodiments of the present disclosure and a bookbinding apparatus connected to the image forming apparatus;

FIG. 2 illustrates an example of information contained in a sheet table;

FIG. 3 is a flowchart illustrating an example of operation of an image forming apparatus according to a first exemplary embodiment;

FIG. 4 illustrates an example of information included in a print job;

FIG. 5 is a schematic perspective view illustrating a sheet stack and a cover sheet;

FIG. 6A is a schematic view illustrating a cover sheet in a flat state, and FIG. 6B is a schematic view illustrating a cover sheet on which a print area without margins on three sides is designated;

FIG. 7 is a flowchart illustrating an example of operation of an image forming apparatus according to a second exemplary embodiment;

FIG. 8 is a flowchart illustrating an example of operation of an image forming apparatus according to a third exemplary embodiment; and

FIG. 9 is a flowchart illustrating an example of operation of an image forming apparatus according to a fourth exemplary embodiment.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION OF EXEMPLARY EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve the same results. For the sake of simplicity, the same reference numerals are used in the drawings and the descriptions for the same materials and constituent parts having the same functions, and redundant descriptions thereof are omitted.

Exemplary embodiments of the present disclosure are now described below with reference to the accompanying drawings. It should be noted that, in a later-described comparative example, exemplary embodiment, and alternative example, the same reference numerals are used for the same constituent elements such as parts and materials having the same functions and achieving the same effects, and redundant descriptions thereof are omitted.

An image forming apparatus according to exemplary embodiments of the present invention is capable of acquiring information on a thickness of a stack of sheets (hereinafter “a sheet stack”) to be bound into a book (hereinafter referred to as bookbinding processing, a bookbinding process, or simply bookbinding), designating an area that serves as a spine after bookbinding based on the acquired thickness information, and forming an image on the designated area.

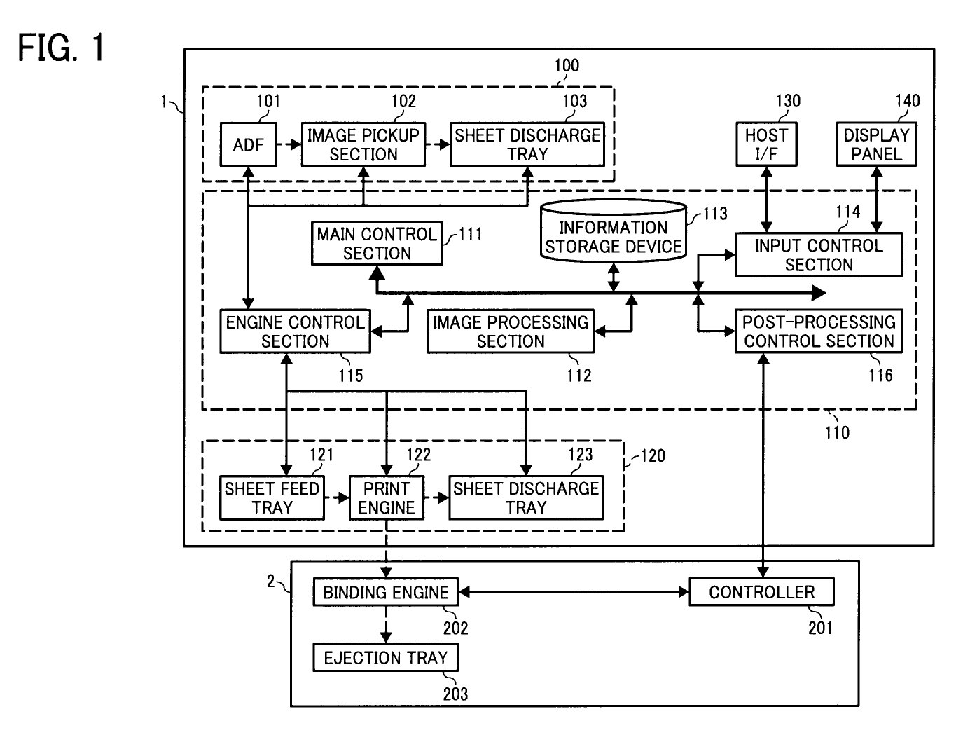

FIG. 1 is a block diagram illustrating a configuration of an image forming apparatus 1 according to a first exemplary embodiment and a bookbinding apparatus connected to the image forming apparatus 1. In FIG. 1, electrical connections are indicated by solid-line arrows, and directions of movement of a sheet or a sheet stack are indicated by dashed-line arrows.

In FIG. 1, the image forming apparatus 1 has an ADF (auto-document feeder) 101, a scanner unit 100, a controller 110, a printer unit 120, a host interface (I/F) 130, and a display panel 140. The scanner unit 100 has an image pickup section 102 and a sheet discharge tray 103. The controller 110 has a main control section 111, an image processing section 112, an information storage device 113, an input control section 114, an engine control section 115, and a post-processing section 116. The printer unit 120 has a sheet feed tray 121, a print engine 122, and a sheet discharge tray 123.

A bookbinding apparatus 2 has a controller 201, a binding engine 202, and an ejection tray 203.

The host I/F 130 is an interface through which the image forming apparatus 1 communicates with other apparatuses, such as a host machine, via a LAN (local area network) or any other suitable line. A print job sent from the host machine is entered in the controller 110 via the host I/F 130, and the controller 110 controls image formation processing so that it is executed in accordance with the print job. The display panel 140 is an input interface, such as a touch panel, through which a user is able to directly operate the image forming apparatus 1.

The controller 110 is formed by a combination of software and hardware. For example, the controller 110 has a software control unit and a hardware control unit. For the software control unit, control programs such as a firmware stored in a ROM (read-only memory), an EEPROM (electronically erasable and programmable ROM), and/or a non-volatile storage medium including a magnetic disc or an optical disc may be loaded into a volatile memory device such as a DRAM (dynamic random access memory). Such control programs are also formed as the software control unit by control of a CPU (central processing unit). On the other hand, the hardware control unit has an integrated circuit and other circuits.

The main control section 111 controls all other control sections included in the controller 110 and transmits instructions to the respective control sections based on signals received or generated by other control sections. The image processing section 112 performs image processing based on image information included in the print job, which is received by the input control section 114, to generate image forming information. The information storage device 113 stores information relating to sheets accommodated in the sheet feed tray 121.

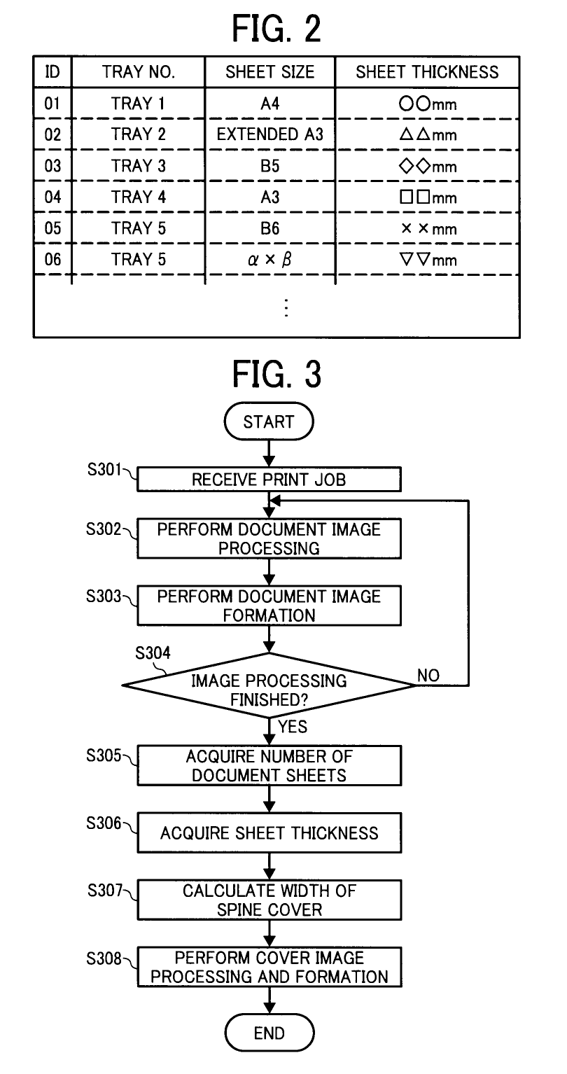

FIG. 2 illustrates an example of information stored in the information storage device 113. It should be noted that the image forming apparatus 1 may have a single sheet feed tray, as shown in FIG. 1, or, as indicated in FIG. 2, the image forming apparatus 1 may have a plurality of sheet feed trays 121 to accommodate a plurality of different types of sheets.

The information storage device 113 stores, as sheet information table, information on sizes, thicknesses, and/or ID (identification data) of different types of sheets stacked in the respective sheet feed trays 121. As illustrated in FIG. 2, the sheet size may be a predetermined size, for example, “A4”, “B5”, or “extended A3”, or it may be a numerical value such as “α×β” directly designated by a user. Such sheet thickness may be designated in units of mm (millimeter).

The input control section 114 transmits, to the main control section 111, the print job entered from a host machine through the host I/F 130 or operation information entered by a user through the display panel 140. The input control section 114 also causes the display panel 140 to display information based on instructions transmitted from the main control section 111 and sends information to the host machine through the host I/F 130.

The engine control section 115 serves as a drive unit to control or drive the printer unit 120 and the scanner unit 100. For example, the engine control section 115 drives a sheet feed roller and a conveyance roller provided to the sheet feed tray 121 based on instructions transmitted from the main control section 111 and conveys a sheet to the print engine 122. The engine control section 115 also drives the print engine 122 based on the image forming information generated by the image processing section 112 and performs image formation on the sheet.

If bookbinding is designated in the print job, the sheet on which an image is formed by the print engine 122 is conveyed to the binding engine 202. Alternatively, if bookbinding is not designated in the print job, the sheet is discharged to the sheet discharge tray 123.

The engine control section 115 drives a document feed plate and a conveyance roller provided to the ADF 101 based on instructions from the main control section 111 and conveys an original document to the image pickup section 102. Further, the engine control section 115 drives the image pickup section 102 to convert optical information on the document into electronic information, thereby generating image information for the document. The document imaged by the image pickup section 102 is discharged to the sheet discharge tray 103.

The post-processing section 116 transmits and receives information to and from the controller 201 of the bookbinding apparatus 2, which is connected to the image forming apparatus 1. When bookbinding, which is one type of post-processing, is designated in the print job received by the input control section 114, the post-processing section 116 sends a bookbinding job to the controller 201 in accordance with the control operation performed by the main control section 111. The controller 201 then drives the binding engine 202 to execute the bookbinding processing. After bookbinding by the binding engine 202, a final product, for example, a bound book, is ejected to the ejection tray 203.

Next, several types of operation of the image forming apparatus 1 are described.

For example, in a case in which the image forming apparatus 1 operates as a printer, when the input control section 114 receives a print job via a USB (universal serial bus) or LAN connected to the host I/F 130, the image processing section 112 receives instructions from the main control section 111 and generates image forming information based on image information included in the print job.

The engine control section 115 controls the print engine 122 and the sheet feed tray 121 to convey a plurality of sheets one by one from the sheet feed tray 121 to the print engine 122. The engine control section 115 also drives the print engine 122 based on the image forming information generated by the image processing section 112 to perform image formation on the sheets. In accordance with the image forming information input from the engine control section 115, the print engine 122, serving as an image forming engine, performs the image formation on the sheet conveyed from the sheet feed tray 121.

Alternatively, when the image forming apparatus 1 operates as a scanner, the input control section 114 sends, to the main control section 111, an operation signal in accordance with an operation requested by a user through the display panel 140. The main control section 111 inputs the operation signal received from the input control section 114 to the engine control section 115.

The engine control section 115 drives the scanner unit 100 to convey an original document loaded on the ADF 101 to the image pickup section 102. An image pickup device, such as CCD (charge-coupled device), provided in the image pickup section 102 optically scans the original document in accordance with the control operation by the engine control section 115 and generates image information from optical information generated by the optical scanning.

When the engine control section 115 receives the image information generated by the scanner unit 100, the engine control section 115 stores the image information in a storage device provided in the image forming apparatus 1 or transmits the image information to the host machine or to an external storage device through the host I/F 130.

Alternatively, when the image forming apparatus 1 operates as a copier, the image processing section 112 generates image forming information based on image information that the engine control section 115 receives from the scanner unit 100. Similar to the above-described printer operation, the engine control section 115 drives the printer unit 120 based on the image forming information.

When executing a print job in which bookbinding is designated, the image forming apparatus 1 thus configured acquires a total number of pages of the original document by referring to results of the image processing executed by the image processing section 112. The image forming apparatus 1 then also acquires, from the information storage device 113, the thickness of at least one sheet of the sheets on which images have been formed, and generates a thickness of a resultant sheet stack, which is a target of the bookbinding processing, based on the thickness of the sheet.

Further, when executing image formation on a cover sheet for covering the sheet stack, the width of a spine area in the cover sheet is determined based on the thickness of the sheet stack, thereby allowing image formation to be correctly performed on each of front, spine, and back cover areas of the cover sheet.

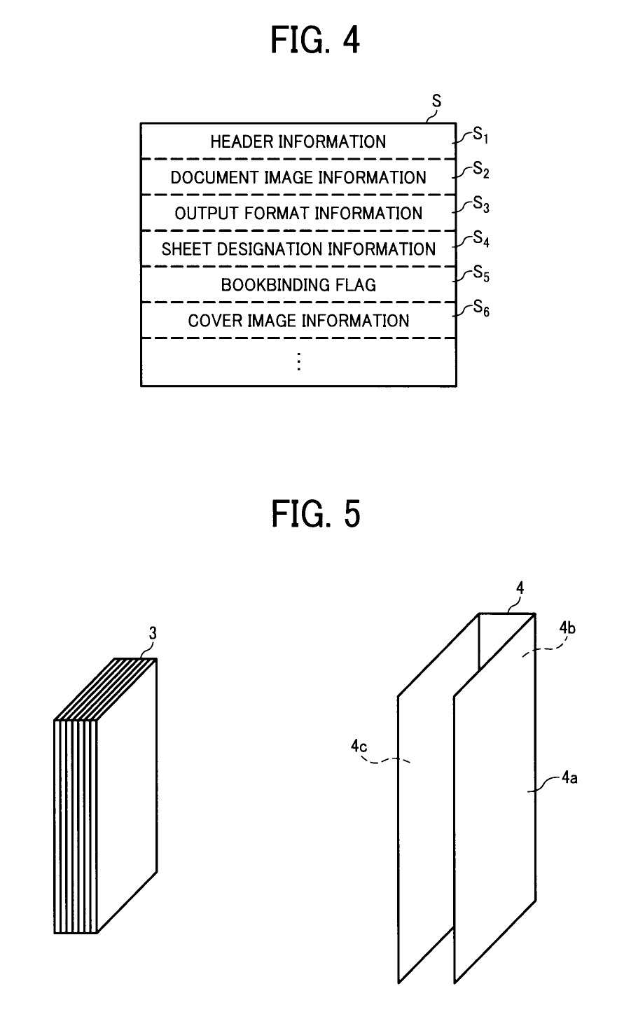

Next, one example of operation of the image forming apparatus 1 is described with reference to FIGS. 3 and 4.

FIG. 3 is a flowchart illustrating one example of operation that the image forming apparatus 1 executes when receiving a print job in which bookbinding is designated. FIG. 4 illustrates an example of information included in a print job in which bookbinding is designated.

At S301, when the image forming apparatus 1 receives a print job transmitted via the host I/F 130 or entered by a user via the display panel 140, the main control section 111 controls relevant sections of the controller 110 to start image forming operation.

In this regard, a plurality of types of information contained in a print job in which bookbinding is designated is described with reference to FIG. 4.

As illustrated in FIG. 4, a print job S includes header information S₁ indicating that the job is a print job, document image information S₂ serving as a source of images formed on sheets, output format information S₃ designating allocation printing and/or duplex printing of the document image information S₂, sheet designation information S₄ designating one tray from among the plurality of sheet feed trays 121, a bookbinding flag S₅ indicating whether or not bookbinding is to be performed, and cover-image information S₆ serving as a source of images formed on a cover sheet. The main control section 111 determines whether or not bookbinding is designated in the print job received by the input control section 114.

In response to the start of the image forming operation, at S302 the image processing section 112 performs image processing based on the document image information S₂ and the output format information S₃ to generate image forming information.

At S303, the engine control section 115 drives the printer unit 120 based on the image forming information generated by the image processing section 112 to perform image formation.

When the image processing section 112 finishes the image processing on the document image information S₂ included in the print job S (“YES” at S304), at S305 the image control section 111 acquires information on a number of sheets on which images having been formed by referring to an execution result of the image processing.

At S306, the main control section 111 refers to the information storage device 113 based on the sheet feed tray designated in the sheet designation information S₄ to acquire information on a thickness of at least one sheet used in the image formation.

At S307, the main control section 111 calculates a width of a spine area in the cover sheet by multiplying the number of the sheets acquired at S305 by the thickness of each sheet acquired at S306. Thus, the main control section 111 serves as an information acquisition unit that acquires information on the width of the spine area of the cover sheet.

At S308, the image processing section 112 executes image processing in accordance with the width of the spine area acquired at S307 and the cover-image information S₆ to generate cover-image forming information. The engine control section 115 drives the printer unit 120 based on the cover-image forming information to execute image formation on the cover sheet, and thus the process ends.

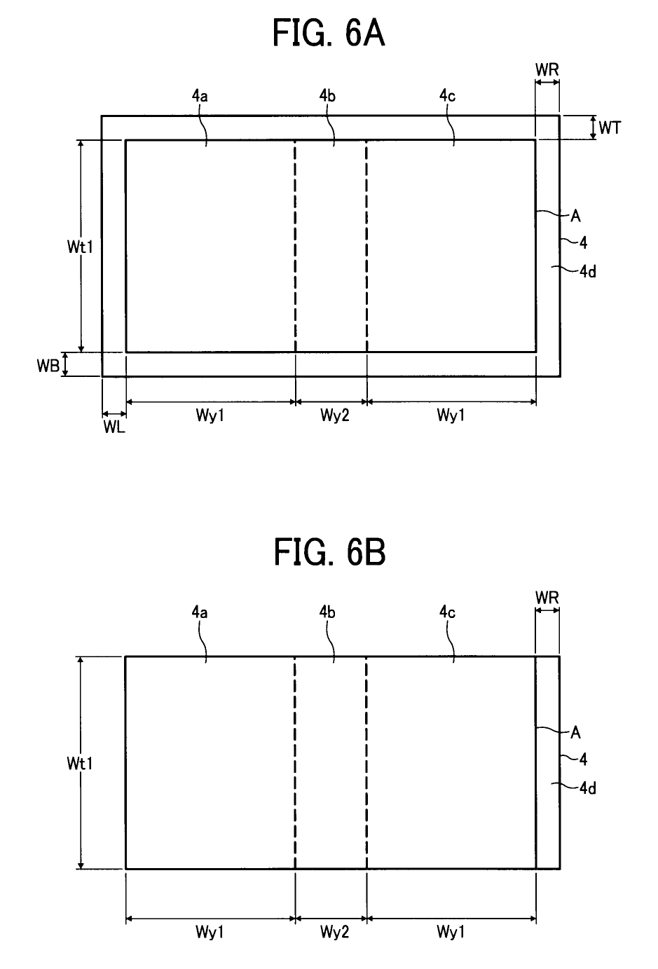

Next, cover-image formation is described with reference to FIGS. 5 and 6A.

FIG. 5 is a schematic perspective view illustrating a sheet stack 3, which is an output result of the document image information S₂ included in the print job S, and a cover sheet 4 used to cover the sheet stack 3.

FIG. 6A is a schematic view illustrating a cover sheet 4 in a flat state before being folded as a cover for the sheet stack 3.

As illustrated in FIGS. 5 and 6A, when the sheet stack 3 is covered with the cover sheet 4, a surface of front cover area 4a of the cover sheet 4 is parallel to a sheet face of the sheet stack 3, and a surface of a back cover area 4b is perpendicular to a surface of a back cover area 4c and the sheet face of the sheet stack 3 and parallel to a thickness direction in which the sheets forming the sheet stack 3 is stacked. As illustrated in FIG. 6A, the cover sheet 4 has a margin 4d, which is cut in a state in which the cover sheet 4 covers the sheet stack 3.

Next, a description is given to designation of a print area executed during the cover-sheet image formation at S308 of FIG. 3.

Hereinafter, a “vertical direction” of the sheet stack 3 or the cover sheet 4 refers to a direction parallel to fold lines along which the cover sheet 4 is folded from the state illustrated in FIG. 6A into the state illustrated in FIG. 5, or a direction parallel to edges contacting the spine area 4b in the state in which the sheet stack 3 is bound. On the other hand, a “horizontal direction” of the sheet stack 3 or the cover sheet 4 refers to a direction perpendicular to the above-described longitudinal direction in the sheet face of a document of the sheet stack 3 or the sheet face of the cover sheet 4.

For example, the length Wt1 of the front cover area 4a, the spine area 4b, or the back cover area 4c in its vertical direction and the length Wy1 in the horizontal direction of the front cover area 4a or the back cover area 4c are acquired by searching the information storage device 113 based on the sheet feed tray designated in the sheet designation information S₄ of the print job S illustrated in FIG. 4 and referring to the information on sheet size stored therein. As illustrated in FIG. 2, if the tray 1 is designated in the sheet designation information S₄, the sheet size used for the printing of the sheet stack 3 is A4, and therefore the lengths Wt1 and Wy1 are determined based on the A4 sheet size.

In this regard, it should be noted that, when the designated sheet size is, for example, A4, the lengths Wt1 and Wy1 are not limited to lengths completely identical to the corresponding standard lengths of the A4-size sheet. For example, the lengths Wt1 and Wy1 may be set greater than the corresponding lengths of the A4 sheet so as to suitably serve as a cover sheet for the sheet stack 3 or to be appropriately folded as illustrated in FIG. 5.

The length Wy2 of the spine area 4b in the horizontal direction is acquired by calculation at S307 of FIG. 3. For example, the length Wy2 is determined based on the thickness T (=P×Q) of the sheet stack 3 acquired by multiplying the number of output sheets P, found at the end of image processing on the sheet stack 3, by the sheet thickness Q, acquired from the information storage device 113 at S306.

It should be noted that the thickness T of the sheet stack 3 is not limited to the thickness completely identical to the length Wy2 of the spine area 4b and may be set greater than the length Wy2 in consideration of an increase in thickness generated by stacking document sheets, a thickness of the cover sheet 4, and adhesive used for bookbinding. Thus, the vertical length Wt1 and the horizontal width 2×Wy1+Wy2 of a print area “A” in the cover sheet 4 are determined.

Assuming coordinates at the upper-left corner of the front cover area 4a in FIG. 6A to be (0, 0), the front cover area 4a is expressed as coordinates between (0, 0) and (Wy1, Wt1). Further, the spine sheet face 4b is expressed as coordinates between (Wy1, 0) and (Wy1+Wy2, Wt1), and the back sheet face 4c is expressed as coordinates between (Wy1+Wy2, 0) and (2×Wy1+Wy2, Wt1).

The margin 4d in the cover sheet 4 is defined by widths WT and WB of margins created at both end portions of the print area “A” in the vertical direction of the cover sheet 4 and widths WL and WR of margins created at both end portions of the print area “A” in the horizontal direction of the cover sheet 4. Such widths of margins in the cover sheet 4 are appropriately determined corresponding to the size of sheet used in printing the cover sheet 4 and/or the specification or setting of the print engine 122.

Alternatively, when outputting the sheet stack 3 in A4 size, a sheet having a vertical length identical to the vertical length of an A4-size sheet and a horizontal width greater than the horizontal width of an A4-size sheet may be used. In such a case, as illustrated in FIG. 6B, image formation is executable so as to create no margins at both end portions of a print area “A” in the vertical direction and a front side (left side in FIG. 6B) in a sheet conveyance direction of the print engine 122, and thus only a margin 4d is created in the cover sheet 4. The margin 4d in the cover sheet 4 is cut off after discharging the cover sheet.

As described above, the image forming apparatus according to the first exemplary embodiment is capable of forming an image in an area that becomes a spine after bookbinding when performing image formation on a cover sheet for covering a sheet stack during bookbinding.

In the above description, as illustrated in S302 through S305 in FIG. 3, after the start of image processing on document image information S₂, image formation is started from an image area in which the image processing has finished. Then, when the image processing is completed on the document image information S₂, the number of printout sheets is acquired from an execution result of the image processing.

It should be noted that the manner for acquiring the number of printout sheets is not limited to that described above. For example, after starting image processing on document image information S₂, the image processing may be completed before starting image formation so that the number of printout sheets can be acquired S302 in advance.

Such a configuration allows image formation on a cover sheet 4 to be performed before image formation on document pages for producing a sheet stack 3. Such a configuration is advantageous when, for example, a particular bookbinding apparatus 2 needs to prepare a cover sheet 4 ahead of a sheet stack 3.

In such a case, when the input control section 114 receives a print job S, preferably the main control section 111 checks whether or not a cover sheet 4 needs to be prepared ahead of a sheet stack 3 in the bookbinding apparatus 2. In one method, the controller 110 holds information on the bookbinding apparatus 2 connected to the image forming apparatus 1, and the main control section 111 checks the information on the bookbinding apparatus 2 and determines whether or not a cover sheet 4 should be output ahead of a sheet stack 3. Alternatively, when the input control section 114 receives a print job S, the main control section 112 queries the bookbinding apparatus 2 via the post-processing section 116 to determine whether or not a cover sheet 4 should be output ahead of a sheet stack 3.

In this regard, when image processing on the document image information S₂ is completed before the start of image formation thereof, the image processing section 112 temporarily stores image forming information, which has been generated in the image processing, in a HDD (hard disk drive) or other storage unit in the image forming apparatus 1. Such a configuration can secure sufficient memory space for executing the image processing.

Further, although in the above description, the number of printout sheets is acquired from an execution result of image processing by the image processing section 112, it should be noted that any other suitable method may be employed to acquire the number of printout sheets. For example, whenever sheets are conveyed one by one from a stack of sheets in the sheet feed tray 121 to the print engine 122 or when sheets are conveyed one by one through the printer unit 120, a counter may be incremented so that the number of printout sheets can be acquired by referring to a count value of the counter when the printing of document is completed.

When the controller 110 acquires the number of printout sheets based on an execution result of image processing, the number of printout sheets needs to be determined in consideration of duplex printing or allocation printing. On the other hand, when the number of printout sheets is acquired from a counted value by the counter in the printer unit 122, such consideration becomes unnecessary thereby facilitating simplification of the image processing.

Next, an image forming apparatus according to a second exemplary embodiment is described.

As described above, in the image forming apparatus according to the first exemplary embodiment, a width of a spine area is calculated based on a number of printout sheets, which is acquired from an execution result of image processing, and a sheet thickness, which is acquired from the information storage device 113.

In an image forming apparatus according to the second exemplary embodiment described below, a thickness of at least one sheet of sheets used to print a document is detected while the sheet is being conveyed through a printer unit 120, and a thickness of a sheet stack 3, which is a stack of sheets printed out from the print unit 120, is obtained from a detection result of the thickness of the sheet.

Incidentally, in the following description, the same reference numerals and characters as those of the first exemplary embodiment are used for components similar or identical to the components of the first exemplary embodiment, and therefore redundant descriptions thereof are omitted.

As describe above, in the image forming apparatus 1 according to the first exemplary embodiment, the controller 110 is capable of acquiring information on sheet thickness from a sheet table stored in the information storage device 113. However, depending on using manners of users, such information on sheet thickness stored in the information storage device 113 may not match a thickness of a sheet actually accommodated in the sheet feed tray 121. In such a case, a calculated value of the width of the spine area acquired by the controller 110 may deviate from an actual value thereof.

In consideration of the above-described case, the image forming apparatus according to the second exemplary embodiment detects a thickness of a sheet being conveyed through the printer unit 120 when executing image formation for a body portion of a book to produce a sheet stack 3. Thus, the image forming apparatus is capable of acquiring accurate information on a thickness of the sheet stack 3 and subsequently a width of a spine area of the book.

The image forming apparatus 1 according to the second exemplary embodiment has a configuration substantially identical to the configuration of the image forming apparatus according to the first exemplary embodiment illustrated in FIG. 1.

In the image forming apparatus 1 according to the second exemplary embodiment, the printer unit 120 has a detector capable of detecting a thickness of a sheet, which is fed from a sheet feed tray 121 and conveyed through the printer unit 120. It should be noted that such a detection capability may be provided to the sheet feed tray 121 or a print engine 122. Alternatively, such a detector may be provided at a sheet conveyance path between the sheet feed tray 121 and the print engine 122 or between the print engine 122 and the sheet discharge tray 123 or a bookbinding apparatus.

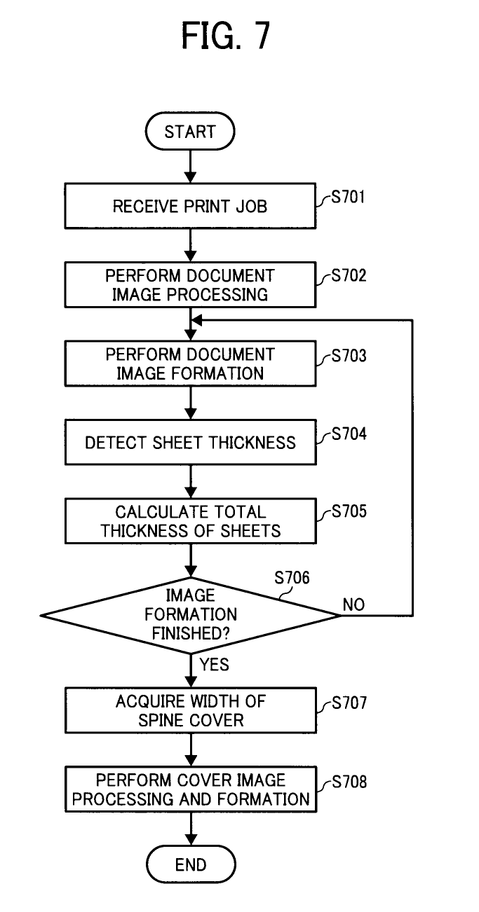

Next, one example of operation of the image forming apparatus 1 according to the second exemplary embodiment is described with reference to FIG. 7.

At S701, when the image forming apparatus 1 receives a print job from an external host machine through a host I/F 130 or a print job relating to, for example, copying operation from a user through a display panel 140, a main control section 111 controls other relevant sections of a controller 110 to start image forming operation.

At S702, in response to the start of image forming operation, an image processing section 112 performs image processing based on document image information S₂ and output format information S₃ to generate image forming information.

At S703, an engine control section 115 drives the printer unit 120 based on the image forming information generated by the image processing section 112 to perform image formation.

At S704, when performing image formation by the printer unit 120, the main control section 111 acquires a thickness of a sheet, which is fed from the sheet feed tray 121 and conveyed through the printer unit 120, from the printer unit 120 or the detector having the detecting capability described above.

In this regard, detecting operation of a thickness of a sheet conveyed through the printer unit 120 is described below in greater detail.

When sheets are fed one by one from the sheet feed tray 121 and conveyed through the printer unit 120, the detector in the printer unit 120 detects and transmits a thickness of each sheet to the engine control section 115.

When the main control section 111 receives the thickness of each sheet transmitted from the engine control section 115, at S705 the main control section 111 temporarily stores the thickness of each sheet in a memory space for summation processing.

At S706, the main control section 111 determines whether or not the image formation has been finished. If the image formation has not been finished (“NO” at S706), the process from S703 to S706 is repeated until it is determined that image formation has been finished (“YES” at S706). If the image formation has been finished, the main control section 111 sums up the thickness of each sheet acquired from the printer unit 120 or the engine control section 115.

Thus, similar to the first exemplary embodiment, in the image forming apparatus 1 according to the second exemplary embodiment, the main control section 111 serves as an information acquisition unit to acquire information on a width of a spine area of a book.

When all image formation for the book body designated in the print job are completed, at S707 the main control section 111 acquires the width of the spine area based on a thickness of a sheet stack 3 obtained from the summation processing of each sheet. It should be noted that the width of the spine area acquired at S707 may not be completely identical to the summation result of the thickness of the sheet stack 3. The width of the spine area may be determined in consideration of an additional thickness generated by stacking the sheets included in the sheet stack 3, a thickness of a cover sheet 4, and adhesive used for bookbinding.

At S708, cover-image formation is executed in a manner similar to the first exemplary embodiment.

As described above, in the image forming operation of the sheet stack 3, the image forming apparatus 1 according to the second exemplary embodiment acquires and sums up thicknesses of sheets conveyed through the printer unit 120 thereby acquiring a width of a spine area in the cover sheet 4. By doing so, the image forming apparatus 1 is capable of reflecting the thicknesses of the sheets, which become the sheet stack 3, directly into the width of the spine area. Accordingly, such a configuration can prevent the main control section 111 from acquiring a value deviating from an actual value due to, for example, an erroneous setting in the image forming apparatus 1.

In the above description, the thicknesses of all sheets output as the sheet stack 3 are detected and summed up to obtain the width of a spine area of a cover sheet. Typically, when printing a book body on sheets, image formation is executed with a single sheet feed tray being designated. In other words, the sheets have substantially identical thicknesses. Accordingly, detection of sheet thickness may be executed only once, thereby simplifying the processing.

On the other hand, in the case in which the thicknesses of all sheets are summed up, the width of the spine area can be precisely determined even when a plurality of sheets having different sizes are accommodated in a plurality of different sheet feed trays 121.

Next, an image forming apparatus according to a third exemplary embodiment is described.

According to the first exemplary embodiment described above, the image forming apparatus 1 acquires information on the width of the spine area to form an image on the spine area 4b. However, depending on a value of the width Wy2 of the spine area 4b, a sheet prepared for the cover sheet 4 in the sheet feed tray 121 may not match a required size. In such a case, when image formation is executed on the cover sheet 4, a partially lost image may be printed out.

Alternatively, in one type of conventional image forming apparatus, a sheet size needs to be determined in advance to form a margin in a middle portion of a cover sheet.

In such cases, respective widths of front cover, back cover, and spine areas needs to be determined in advance to use a sheet having a width greater than a total width of the respective areas. Otherwise, in a case in which the width of the spine area is relatively great, that is, a resultant sheet stack 3 has a relatively great thickness, the front and back cover areas may not completely cover the sheet stack 3. Consequently, an error may occur in a bookbinding apparatus 2 thereby requiring redoing the image formation on the cover sheet. Further, if bookbinding processing has been completed at that time, it may be needed to redo the image formation of the sheet stack 3 as well.

On the other hand, according to the third exemplary embodiment described below, when acquiring a width Wy2 of a spine area, an image forming apparatus 1 compares a size of a print area “A” with a sheet size designated for cover-image formation to determines whether or not the sheet size designated by a user is compatible with the size of the print area “A”.

Incidentally, in the following description, the same reference numerals and characters as those of the first exemplary embodiment are used for components similar or identical to the components of the first exemplary embodiment, and therefore redundant descriptions thereof are omitted.

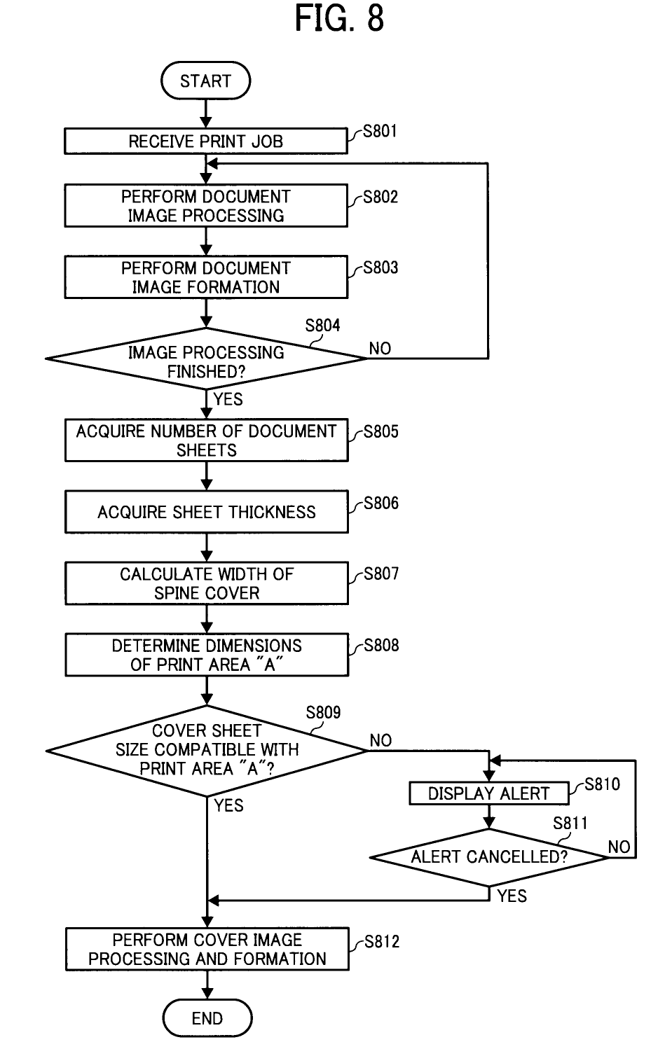

Next, one example of operation of the image forming apparatus 1 according to the third exemplary embodiment is described with reference to FIG. 8.

The process from receiving a print job at S801 through calculating a width Wy2 of a spine area at S807 is executed in the same manner as the process from S301 through S307 of the first exemplary embodiment described with reference to FIG. 3.

When acquiring the width Wy2 of the spine area by the calculation at S807, at S808 the main control section 111 determines dimensions of the print area “A” based on dimensions Wy1 and Wt1 of a front cover area 4a and a back cover area 4c. The dimensions of the print area “A” may be determined according to the manner described with reference to FIG. 6.

Further, when the main control section 111 acquires information on dimensions of a sheet (hereinafter “designated sheet”) designated for a cover sheet 4 in a print job S, at S809 the main control section 111 compares the dimensions of the designated sheet with the dimensions of the print area “A” determined at S808.

As a result of the comparison, if the dimensions of the designated sheet are compatible with the dimensions of the print area “A” (“YES” at S809), at S812 cover-image formation is executed in a manner similar to, if not the same as, the manner of the first exemplary embodiment, and the process ends.

Alternatively, if the dimensions of the designated sheet are not compatible with the dimensions of the print area “A” (“NO” at s809), at S810 the main control section 111 causes an input control section 114 to display an alert screen on a display panel 140 or to transmit an alert message to a host machine via a host I/F 130.

When such alert is cancelled by a user's request for changing the designated sheet, forcible execution, or the like (“YES” at S811), at S812 the cover-image formation is executed in the manner similar to, if not the same as, the manner described for the first exemplary embodiment, and the process ends.

As described above, the image forming apparatus 1 the third exemplary embodiment determines the width Wy2 of a spine area, specify a print area “A” of a cover sheet 4, and then compares the size of the print area “A” with a size of a sheet designated as the cover sheet 4. By doing so, the image forming apparatus is capable of suppressing a failure that a target image is printed beyond edge(s) of the cover sheet 4, thereby preventing an operation error in a bookbinding apparatus, redoing the image formation of the cover sheet 4, and redoing the image formation of the sheet stack 3.

Next, an image forming apparatus 1 according to a fourth exemplary embodiment is described.

In each of the first to three exemplary embodiments described above, the image forming apparatus 1 acquires a width of a spine area of a cover sheet using its internal component. In the fourth exemplary embodiment, the image forming apparatus 1 acquires such a width of a spine area by transmitting and receiving information to and from a bookbinding apparatus 2.

Incidentally, in the following description, the same reference numerals and characters as those of the first to three exemplary embodiments are used for components similar or identical to the components of the first exemplary embodiment, and therefore redundant descriptions thereof are omitted.

Overall configurations of an image forming apparatus 1 and a bookbinding system 2 according to the fourth exemplary embodiment are similar to those of the first exemplary embodiment illustrated in FIG. 1. Further, according to the fourth exemplary embodiment, the bookbinding apparatus 2 has a capability of directly detecting a thickness of a sheet stack 3 by sandwiching the sheet stack 3 with a binding engine 202 or any other suitable component.

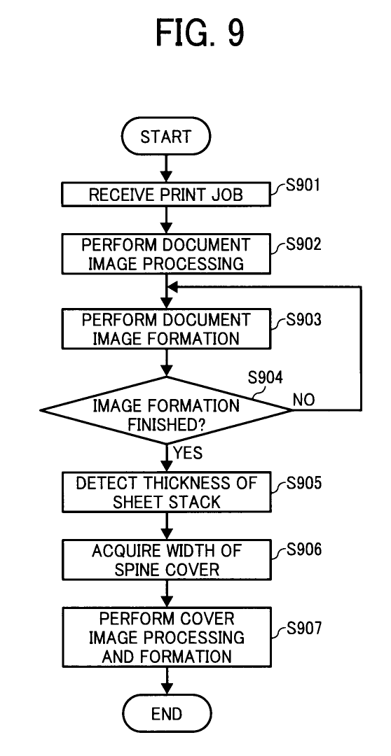

Next, one example of operation of the image forming apparatus 1 according to the fourth exemplary embodiment and the bookbinding system 2 connected to the image forming apparatus 1 is described with reference to FIG. 9.

Process from receiving a print job at S901 to performing image formation of a book body at S903 is carried out in a manner similar to, if not the same as, the processing from S301 to S303 of FIG. 3 described in the first exemplary embodiment.

When a printer unit 120 completes the image formation of the book body (“YES” at S904), sheets on which pages of the book body have been printed are conveyed and held as a sheet stack 3 in the bookbinding apparatus 2.

At S905, the bookbinding apparatus 2 detects a thickness “T” of the sheet stack 3 by sandwiching the sheet stack 3 in a direction in which the sheets included in the sheet stack 3 are stacked.

At S906, a main control section 111 acquires the thickness T of the sheet stack 3 from the bookbinding apparatus 2 and determines a width of a spine area of a cover sheet based on the thickness T of the sheet stack 3.

It should be noted the thickness T of the sheet stack 3 may not need to be completely identical to the width of the spine area. Thus, according to the fourth exemplary embodiment, the thickness T of the sheet stack 3 is detected by actually sandwiching the sheet stack 3, thereby allowing the width of the spine area to be more precisely determined as a value including an additional thickness generated by stacking the sheets.

At S907, a cover image is formed on the cover sheet in a manner similar to, if not the same as, the manner described in the first exemplary embodiment, and thus the process ends.

Incidentally, for the acquisition of the thickness of the sheet stack 3 by the main control section 111 at S906, the main control section 111 may send a notice that an engine control section 115 has completed all the processing of book-body-image formation, and, in response to the notice, the main control section 111 may send an inquiry to the bookbinding apparatus 2.

Alternatively, after the processing of book-body-image formation is completed and the thickness of the sheet stack 3 is detected in the bookbinding apparatus 2, the controller 201 of the bookbinding apparatus 2 may send the thickness of the sheet stack 3 to a post-processing control section 116. In such a case, after the thickness of the sheet stack 3 is input from the controller 201 to the post-processing control section 116, the main control section 111 may execute the image formation on the cover sheet.

As described above, the image forming apparatus 1 according to the fourth exemplary embodiment acquires the thickness of the sheet stack 3 from the bookbinding apparatus 2 to determine the width Wy2 of the spine area. Thus, by referring to a detection result in the bookbinding apparatus 2 which finally executes bookbinding, errors that may be generated between the image forming apparatus 1 and the bookbinding apparatus 2 may be prevented from affecting the determination of the width Wy2 of the spine area, thereby allowing the width Wy2 to be determined with more precise dimensions.

Alternatively, depending on functions of the detector provided in the bookbinding apparatus 2, the detector is capable of actually sandwiching the sheet stack 3 to detect the thickness of the sheet stack 3 including additional thickness caused by stacking document sheets. Thus, the detector is capable of detecting a value considerably closer to the width of the spine area as the thickness of the sheet stack 3.

In the first to third exemplary embodiments described above, a print job of a book body for generating a sheet stack 3 needs to be associated with a print job of a cover sheet 4.

On the other hand, as described above, the image forming apparatus 1 according to the fourth exemplary embodiment determines the width Wy2 of the spine area by referring to information sent from the bookbinding apparatus 2 to execute image formation on the cover sheet 4. Accordingly, the image forming apparatus 1 is capable of executing the image formation on the cover sheet 4 independently of image formation on the sheet stack 3.

In such a case, for example, a user may set a sheet stack 3 on which image formation is completed to the bookbinding apparatus 2, and then enter to the image forming apparatus 1a print job indicating that the print job is about a cover sheet 4 for binding the sheet stack 3 having been set to the bookbinding apparatus 2.

More specifically, when the print job is input to the input control section 114, the main control section 111 determines whether the print job is for a book body or for a cover sheet. If the print job is for a cover sheet, the main control section 111 acquires a thickness of the sheet stack 3 having been set in the bookbinding apparatus 2 and then executes image formation on the cover sheet 4.

In the above description, the bookbinding apparatus 2 connected to the image forming apparatus 1 is described as one example of the apparatus capable of detecting the thickness of the sheet stack 3 and notifying the thickness to the main control section 111.

It should be noted that the apparatus is not limited to the bookbinding apparatus 2 and may be any other suitable apparatus to which such a sheet stack is conveyed after image formation in the image forming apparatus 1. Alternatively, the apparatus may be an specific apparatus capable of detecting the total thickness of sheets that are previously bound as the sheet stack 3 or any other apparatus connected to the sheet conveyance path between the image forming apparatus 1 and the bookbinding apparatus 2. Further, a user may directly designate a width Wy2 of a spine area through the display panel 140.

Next, a fifth exemplary embodiment is described below.

In the first to fourth exemplary embodiments described above, image formation is executed on a cover sheet after designating a width Wy2 of a spine area.

On the other hand, in the fifth exemplary embodiment, after designation of a width Wy2, the width Wy2 is notified to the user so that the user can modify the width Wy2.

In the following description, the same reference numerals and characters as those of the first to third exemplary embodiments are used for components similar or identical to the components of the first exemplary embodiment, and therefore redundant descriptions thereof are omitted.

Overall configurations of an image forming apparatus 1 and a bookbinding apparatus 2 according to the fifth exemplary embodiment are substantially similar to the image forming apparatus 1 and the bookbinding apparatus 2 of FIG. 1 described in the first exemplary embodiment.

In the image forming apparatus 1 according to the fifth exemplary embodiment, a main control section 111 controls an input control section 114 to display a width Wy2 of a spine area on a display panel 140. A user can see and confirm the designated width Wy2 on the display panel 114.

In the example of FIG. 3 or 8, there is a certain period of time from designating a width of a spine area to starting image formation on a cover sheet. Accordingly, during such a period of time, the user can input correction information to correct the width Wy2 of the spine area through the display panel 140.

Alternatively, for the example of FIG. 7 or 9, the image forming apparatus 1 continuously waits the execution of image formation on the cover sheet from displaying a width Wy2 of a spine area designated by a user to receiving an instruction for the execution of the image formation from the user, thereby allowing the user to correct the width Wy2 of the spine area. In this regard, when executing image processing on the cover image, the image processing section 112 refers to the correction information for the spine area in addition to the designated width Wy2 and the cover-image information S₆.

For example, when outputting a plurality of copies of an original document to produce a plurality of bound books, such a configuration allows a user to correct the width Wy2 of the spine area for a second or subsequent copy based on an output or binding result of the first copy. Specifically, when print-out and bookbinding of a plurality of copies are designated in a print job for a document, the main control section 111, subsequent to outputting a first copy and prior to outputting a second copy, controls the engine control section 115 to interrupt the drive of a printer unit 120 and controls an input control section 114 to display on a display panel 140 whether or not the width Wy2 of the spine area needs to be corrected. Thus, the image forming apparatus 1 is capable of correcting and optimizing a bookbinding mode for the second or subsequent copy of the document based on the output or bookbinding result of the first copy.

Further, when the user enters a correction value for the width Wy2 of the spine area, the controller 110 may store the correction value as an optimal value to learn a difference between the calculated value of the spine width Wy2 and the optimal value. Such a configuration facilitates optimizing the determination of the spine width Wy2 based on the product of a sheet thickness and a number of printed sheets, the determination based on the summation of sheet thicknesses, and the determination based on the thickness of a sheet stack 3, which are described above in the first, second, and fourth exemplary embodiments, respectively.

In the first and fifth exemplary embodiments, bookbinding is executed for sheets carrying some information on their surfaces, such as a sheet stack on which images are formed by the image forming apparatus 1.

It should be noted that the word “bookbinding” used herein includes any other suitable process in which a stack of sheets is bound into a book form. For example, the above-described or other exemplary embodiments are applicable to a case in which a stack of clean sheets are bound to produce a notebook. In other words, the word “bookbinding” used herein includes a process in which a stack of clean sheets is covered with a cover sheet to attach front, spine, and back covers to the stack.

Exemplary embodiments of the present invention may be conveniently implemented using a conventional general purpose digital computer programmed according to the teachings of the present specification, as will be apparent to those skilled in the computer art. Appropriate software coding can readily be prepared by skilled programmers based on the teachings of the present invention, as will be apparent to those skilled in the software art. Exemplary embodiments of the present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that, within the scope of the appended claims, the disclosure of this application may be practiced otherwise than as specifically described herein.

Further, elements and/or features of different exemplary embodiments and/or examples may be combined with each other and/or substituted for each other within the scope of this disclosure and appended claims.

Still further, any one of the above-described and other exemplary features of the present invention may be embodied in the form of an apparatus, method, system, computer program, or computer program product. For example, the aforementioned methods may be embodied in the form of a system or device, including, but not limited to, any of the structures for performing the methodology illustrated in the drawings.

Even further, any of the aforementioned methods may be embodied in the form of a program. The program may be stored on a computer readable medium and configured to perform any one of the aforementioned methods when run on a computer device (a device including a processor). Thus, the storage medium or computer readable medium can be configured to store information and interact with a data processing facility or computer device to perform the method of any of the above-described embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media (such as CD-ROMs and DVDS), magneto-optical storage media (such as MOs), magnetic storage media (including but not limited to floppy diskettes, cassette tapes, and removable hard disks), media with a built-in rewriteable non-volatile memory (including but not limited to memory cards), and media with a built-in ROM (including but not limited to ROM cassettes), etc. Furthermore, various information regarding stored images, for example, property information, may be stored in any other form, or provided in other ways.

Examples and embodiments being thus described, it should be apparent to one skilled in the art after reading this disclosure that the examples and embodiments may be varied in many ways. Such variations are not to be regarded as a departure from the spirit and scope of the present invention, and such modifications are not excluded from the scope of the following claims.

What is claimed is:

1. An image forming apparatus connectable to a bookbinding apparatus that binds a sheet stack with a cover sheet to produce a book, the cover sheet comprising a front cover area, a back cover area, and a spine area located between the front cover area and the back cover area, the image forming apparatus comprising:
an information acquisition unit configured to acquire information on a width of the spine area in the cover sheet prior to binding the sheet stack;
an area designation unit configured to designate an image formation area on which an image is to be formed in the cover sheet based on the information on the width of the spine area acquired by the information acquisition unit, the image formation area including the spine area; and
an image forming unit configured to form the image in the image formation area designated by the area designation unit.

2. The image forming apparatus according to claim 1, further comprising a sheet feed tray configured to accommodate a plurality of sheets,
wherein the image forming unit forms images on the plurality of sheets fed from the sheet feed tray to generate the sheet stack and the information acquisition unit acquires the information on the width of the spine area based on a thickness of at least one sheet of the plurality of sheets and on a number of sheets included in the sheet stack.

3. The image forming apparatus according to claim 1, further comprising:
a plurality of sheet feed trays configured to accommodate a plurality of sheets of different sizes; and
a storage device configured to store information on the plurality of sheets of different sizes as a sheet information table,
wherein, when receiving an instruction for executing image formation on one sheet size accommodated in one sheet feed tray among the plurality of sheet feed trays, the information acquisition unit acquires information on a thickness of the sheet size from the sheet information table stored in the storage device.

4. The image forming apparatus according to claim 2, further comprising a detector to detect the thickness of at least one sheet of the plurality of sheets,
wherein the information acquisition unit determines the information on the width of the spine area based on the thickness of at least one sheet detected by the detector.

5. The image forming apparatus according to claim 2, wherein the image forming unit comprising:
an image processing section configured to generate image forming information based on image information contained in an instruction for executing image formation on a plurality of sheets; and
an image forming engine configured to execute the image formation based on the image forming information generated by the image processing section, and
wherein, based on the image forming information, the information acquisition unit determines a number of the sheets included in the sheet stack.

6. The image forming apparatus according to claim 5, further comprising a determination unit configured to select one image formation order from among a first image formation order and a second image formation order based on a type of bookbinding apparatus connected to the image forming apparatus after the image processing section generates the image forming information,
wherein image formation is executed first on the sheet stack and then on the cover sheet in the first image formation order, and image formation is executed first on the cover sheet and then on the sheet stack in the second image formation order.

7. The image forming apparatus according to claim 2, further comprising a counter configured to count a number of sheets used in the image formation of the sheet stack,
wherein the information acquisition unit determines the number of the sheets included in the sheet stack based on the number of the sheets counted by the counter.

8. The image forming apparatus according to claim 1,
further comprising an external detector connected to the image forming apparatus and configured to detect a thickness of the sheet stack,
wherein the information acquisition unit acquires information on the thickness of the sheet stack from the external detector,
the information acquisition unit determining the information on the width of the spine area based on the information on the thickness of the sheet stack.

9. The image forming apparatus according to claim 3, wherein the information acquisition unit issues an alert when a sheet size designated in the instruction for executing image formation on the cover sheet is incompatible with the image formation area designated by the area designation unit.

10. The image forming apparatus according to claim 1, further comprising:
a display device configured to display information based on the information on the width of the spine area acquired by the information acquisition unit; and
an input device for inputting a correction to the width of the spine area based on the information displayed on the display device,
wherein the area designation unit designates the image formation area based on the information on the width of the spine area and the correction input through the input device.

11. The image forming apparatus according to claim 10, wherein the information acquisition unit stores the correction to the width of the spine area and corrects the information on the width of the spine area based on the stored correction.

12. A method of controlling an image forming apparatus connectable to a bookbinding apparatus that binds a sheet stack with a cover sheet to produce a book, the cover sheet comprising a front cover area, a back cover area, and a spine area located between the front cover area and the back cover area,
the method comprising:
acquiring information on a width of the spine area in the cover sheet prior to binding the sheet stack;
designating an image formation area in which an image is to be formed in the cover sheet based on the information on the width of the spine area acquired in the acquiring, the image formation area including the spine area; and
forming the image in the image formation area designated by the designating.

13. A computer-readable storage medium storing a computer program that causes a computer to execute a method of controlling an image forming apparatus connectable to a bookbinding apparatus that binds a sheet stack with a cover sheet to produce a book, the cover sheet comprising a front cover area, a back cover area, and a spine area located between the front cover area and the back cover area
the method comprising:
acquiring information on a width of the spine area in the cover sheet prior to binding the sheet stack;
designating an image formation area in which an image is to be formed in the cover sheet based on the information on the width of the spine area acquired in the acquiring, the image formation area including the spine area; and
forming the image in the image formation area designated by the designating.
